(19) United States
(12) Patent Application Publication
(10) Pub. No.: US 2026/0302686 A1
(43) Pub. Date: Oct. 1, 2026

(54) POWER CONNECTOR

(71) Applicant: OUPIIN ELECTRONIC (KUNSHAN) CO., LTD., Kunshan City (CN)

(72) Inventor: Hsin Chih CHEN, Kunshan City (CN)

(21) Appl. No.: 19/255,630

(22) Filed: Jun. 30, 2025

(30) Foreign Application Priority Data
Apr. 1, 2025 (CN) 202510402711.X
Apr. 1, 2025 (CN) 202520600077.6

(51) Int. Cl. H01R 13/53

(52) U.S. Cl. CPC H01R 13/53

(57) ABSTRACT

A power connector is disclosed in this application. The power connector includes an insulation case, a first power terminal and a second power terminal. The first power terminal and the second power terminal are stacked and arranged in the insulation case. A first contact of the first power terminal and a second contact of the second power terminal enter a slot, and are adjacent to each other along a depth direction of the slot. The second contact is used to make electrical contact with an insert only after the first contact is in electrical contact with the insert, thereby avoiding arcing on the second contact and damaging it. Furthermore, when the second contact is in electrical contact with the insert, the first contact is lifted away from the insert.

### CROSS REFERENCE TO RELATED APPLICATIONS

This application claims priority based on Chinese Patent Application No. 202510402711.X filed on Apr. 1, 2025, and Chinese Patent Application No. 202520600077.6 filed on Apr. 1, 2025. The entire contents of the above-mentioned patent applications are incorporated herein by reference for all purposes.

### FIELD OF ART

The present application relates to a field of connector technology, and more specifically to a power connector.

### BACKGROUND OF DISCLOSURE

When a power connector is connected to the device, it will generate an arc, which will generate high heat and damage contacts of the power connector. This will affect a normal operation of the power connector.

In order to reduce the generation of arcs, a detection terminal is installed in some power connectors to ensure that a plug is connected to a socket before power supply. However, how to ensure that the power connector can still work properly in a compact space has become a technical direction for industry research.

Hence, the inventor of the present application has developed a power connector that can still work normally without a detection terminal.

### BRIEF SUMMARY OF DISCLOSURE

One object of the present application is to provide a power connector, which adopts two stacked power terminals being respectively provided with a first contact and a second contact, wherein the second contact can be protected from arc damage by sacrificing the first contact, thereby ensuring that the second contact can transmit power normally and the power connector can work properly.

The other object of the present application is to provide a power connector, which adopts two pairs of stacked power terminals, wherein each pair of stacked power terminals can sacrifice one contact to protect the other contact from arc damage, thereby ensuring that the other contact can transmit power normally and the power connector can work properly.

Other objects and advantages of the present application may be further understood from technical features disclosed by the present application.

To achieve the above objects of the present application, the present application adopts the following technical solution.

A power connector comprises an insulation case, a first power terminal and a second power terminal. The insulation case has a mating section and an assembly section. The mating section bis provided with a slot for inserting an insert. The first power terminal has a first retaining plate located in the assembly section and at least one first elastic arm located in the mating section. The first elastic arm forms a first contact that enter the slot. The second power terminal is stacked on one side of the first power terminal facing the slot and being assembled together with the first power terminal into the insulation case. The second power terminal has a second retaining plate stacked with the first retaining plate and at least one second elastic arm stacked with the first elastic arm. The second elastic arm forms a second contact that enter the slot. Wherein, the first contact and the second contact are adjacent to each other along a depth direction of the slot; the first contact is used to first make electrical contact with the insert, and the second contact is used to make electrical contact with the insert only after the first contact is in electrical contact with the insert, and lift the first contact away from the insert.

In one embodiment, in a height direction of the slot, the first contact and the second contact have same height.

In one embodiment, in a height direction of the slot, the second contact is lower than the first contact for entering more into the slot compared to the first contact.

In one embodiment, the first elastic arm and the second elastic arm are both inclined toward the slot.

In one embodiment, the first elastic arm has a first fixed end and a first free end, and the first elastic arm is sequentially provided with a first inclined section, a first bent section, and a first protruding structure from the first fixed end to the first free end; wherein, the first protruding structure protrudes toward the slot, and forms the first contact on one side of the first protruding structure facing the slot; and the second elastic arm has a second fixed end and a second free end, and the second elastic arm is sequentially provided with a second inclined section, a second bent section, and a second protruding structure from the second fixed end to the second free end; wherein, the second protruding structure protrudes toward the slot, and forms the second contact on one side of the second protruding structure facing the slot; wherein, the first inclined section and the second inclined section are stacked together; wherein, a first bending angle of the first bent section is greater than a second bending angle of the second bent section; and wherein, the second contact is corresponding to the first inclined section and is located on one side of the first inclined section facing the slot.

In one embodiment, the first power terminal has a first connection section for connecting the first retaining plate and the first elastic arm, and the first power terminal is Z-shaped; and the second power terminal has a second connection section for connecting the second retaining plate and the second elastic arm, and the second power terminal is Z-shaped; wherein, the second connection section is stacked with the first connection section.

In one embodiment, the power connector further comprises a first reinforcement sheet being stacked and fixed on one side of the first power terminal facing away from the second power terminal; wherein, the first reinforcement sheet covers a portion of the first elastic arm, the first connection section, and a portion of the first retaining plate.

In one embodiment, the first power terminal has multiple of the first elastic arms arranged in a row along a length direction of the slot; and the second power terminal has multiple of the second elastic arms arranged in a row along the length direction of the slot.

To achieve the above objects of the present application, the present application also adopts the following technical solution.

A power connector comprises an insulation case, a first power terminal, a second power terminal, a third power terminal and a fourth power terminal. The insulation case has a mating section and an assembly section. The mating section is provided with a slot for inserting an insert. The slot has a first side and a second side, which are oppositely arranged and are corresponding to a first conductive surface and a second conductive surface of the insert, respectively. The first power terminal has a first retaining plate located in the assembly section and at least one first elastic arm located in the mating section. The first elastic arm forms a first contact that enter the slot from the first side. The second power terminal is stacked on one side of the first power terminal facing the slot and being assembled together with the first power terminal into the insulation case. The second power terminal has a second retaining plate stacked with the first retaining plate and at least one second elastic arm stacked with the first elastic arm. The second elastic arm forms a second contact that enter the slot from the first side. The third power terminal is independent of the first and second power terminals, and has a third retaining plate located in the assembly section and at least one third elastic arm located in the mating section. The third elastic arm forms a third contact that enter the slot from the second side. The fourth power terminal is independent of the first and second power terminals, is stacked on one side of the third power terminal facing the slot, and is assembled together with the third power terminal into the insulation case. The fourth power terminal has a fourth retaining plate stacked with the third retaining plate and at least one fourth elastic arm stacked with the third elastic arm. The fourth elastic arm forms a fourth contact that enter the slot from the second side. Wherein, the first contact and the second contact are adjacent to each other along a depth direction of the slot; the first contact is used to first make electrical contact with the first conductive surface of the insert, and the second contact is used to make electrical contact with the first conductive surface of the insert only after the first contact is in electrical contact with the insert, and lift the first contact away from the insert. Wherein, the third contact and the fourth contact are adjacent to each other along the depth direction of the slot; the third contact is used to first make electrical contact with the second conductive surface of the insert, and the fourth contact is used to make electrical contact with the second conductive surface of the insert only after the third contact is in electrical contact with the insert, and lift the third contact away from the insert.

In one embodiment, the first power terminal and the third power terminal have a same structure and are symmetrically arranged in the insulation case; and the second power terminal and the fourth power terminal have a same structure and are symmetrically arranged in the insulation case.

In one embodiment, the first power terminal has a first connection section located between the first retaining plate and the first elastic arm; the second power terminal has a second connection section stacked with the first connection section and located between the second retaining plate and the second elastic arm; the third power terminal has a third connection section located between the third retaining plate and the third elastic arm; and the fourth power terminal has a fourth connection section stacked with the third connection section and located between the fourth retaining plate and the fourth elastic arm.

In one embodiment, the first retaining plate, the second retaining plate, the third retaining plate and the fourth retaining plate are parallel to each other; a plate spacing is formed between the second retaining plate and the fourth retaining plate; and a connection spacing is formed between the second connection section and the fourth connection section; wherein, the plate spacing is less than the connection spacing.

In one embodiment, the second elastic arm has a second fixed end and a second free end, and the second contact is adjacent to the second free end; the fourth elastic arm has a fourth fixed end and a fourth free end, and the fourth contact is adjacent to the fourth free end; a first spacing is formed between the second fixed end and the fourth fixed end; and a second spacing is formed between the second contact and the fourth contact; wherein, the second spacing is less than the first spacing; and the first spacing is greater than the plate spacing.

In one embodiment, the first retaining plate is fixedly connected to at least one first power cable through a first welding plate; the first welding plate is fixed on one side of the first retaining plate facing away from the second retaining plate; the third retaining plate is fixedly connected to at least one second power cable through a second welding plate; and the second welding plate is fixed on one side of the third retaining plate facing away from the fourth retaining plate.

In one embodiment, the power connector further comprises a first reinforcement sheet and a second reinforcement sheet. The first reinforcement sheet is stacked and fixed on one side of the first power terminal facing away from the second power terminal. Wherein, the first reinforcement sheet covers a portion of the first elastic arm, the first connection section, and a portion of the first retaining plate. The second reinforcement sheet is stacked and fixed on one side of the third power terminal facing away from the fourth power terminal. Wherein, the second reinforcement sheet covers a portion of the third elastic arm, the third connection section, and a portion of the third retaining plate.

In comparison with the prior art, the power connector of the present application adopts the first power terminal and the second power terminal stacked together to commonly transmit power. The first power terminal and the second power terminal are respectively provided with the first contact and the second contact arranged adjacent to each other along the depth direction of the slot. Therefore, the first contact can make electrical contact with the insert first, which may cause arcing and damage the first contact. However, as the insert continues to be inserted, the second contact will normally make electrical contact with the insert without arc. Meanwhile, since the first contact can be successfully lifted by the second contact when the second contact makes electrical contact with the insert, the first contact damaged by arc will not affect power transmission. In addition, although the first contact is lifted, since the first power terminal and the second power terminal are stacked together, the first power terminal can still transmit power together with the second power terminal. Similarly, for the third power terminal and the fourth power terminal stacked together, the fourth contact can be protected from arc damage by sacrificing the third contact, thereby ensuring that the fourth contact can transmit power normally and the power connector can work properly.

### BRIEF DESCRIPTION OF DRAWINGS

FIG. 1 is a perspective schematic view of a power connector according to one embodiment of the present application;

FIG. 2 is an exploded view of the power connector according to one embodiment of the present application;

FIG. 3 is a sectional schematic view of the power connector according to one embodiment of the present application;

FIG. 4 is a sectional schematic view of the power connector according to one embodiment of the present application, mainly showing an electrical contact state of a first contact and an insert;

FIG. 5 is a sectional schematic view of the power connector according to one embodiment of the present application, mainly showing that a second contact is in electrical contact with the insert and the first contact is lift away from the insert;

FIG. 6 is a structure schematic view of all power terminals according to one embodiment of the present application;

FIG. 7 is a schematic plan view of the positional relationship of all power terminals according to one embodiment of the present application; and

FIG. 8 is a schematic plan view of the positional relationship of all power terminals and power cables according to one embodiment of the present application.

### DETAILED DESCRIPTION OF PREFERRED EMBODIMENTS

The following description of every embodiment with reference to the accompanying drawings is used to exemplify a specific embodiment, which may be carried out in the present application. Directional terms mentioned in the present application, such as “top”, “bottom”, “front”, “back”, “left”, “right”, “upper”, “lower” etc., are only used with reference to the orientation of the accompanying drawings. Therefore, the used directional terms are intended to illustrate, but not to limit, the present application.

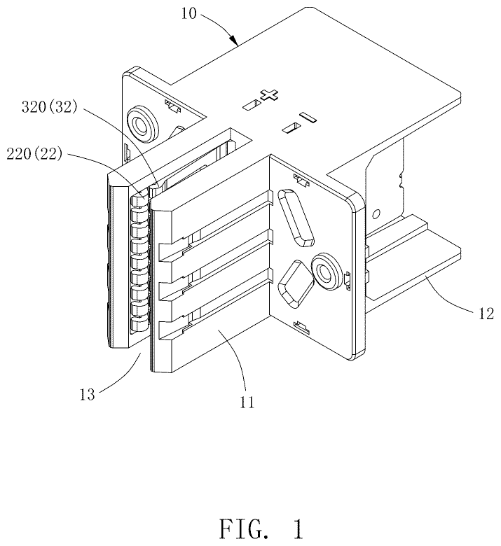

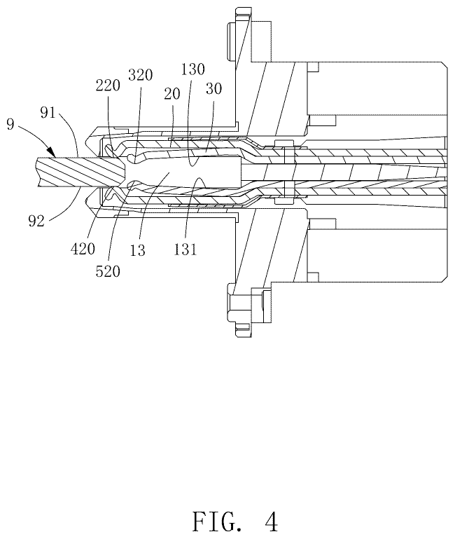

Please refer to FIGS. 1 to 3, a power connector 1 of the present application at least includes an insulation case 10, a first power terminal 20 and a second power terminal 30. The insulation case 10 has a mating section 11 and an assembly section 12. The mating section 11 is provided with a slot 13 for inserting an insert 9 (label seen in FIG. 4). The first power terminal 20 is assembled in the insulation case 10, and has a first retaining plate 21 located in the assembly section 12 and at least one first elastic arm 22 located in the mating section 11. The first elastic arm 22 forms a first contact 220 that enter the slot 13. A second power terminal 30 is stacked on one side of the first power terminal 20 facing the slot 13 and is assembled together with the first power terminal 20 into the insulation case 10. The second power terminal 30 has a second retaining plate 31 stacked with the first retaining plate 21 and at least one second elastic arm 32 stacked with the first elastic arm 22. The second elastic arm 32 forms a second contact 320 that enter the slot 13. Wherein, the first contact 220 and the second contact 320 are adjacent to each other along a depth direction A1 of the slot 13.

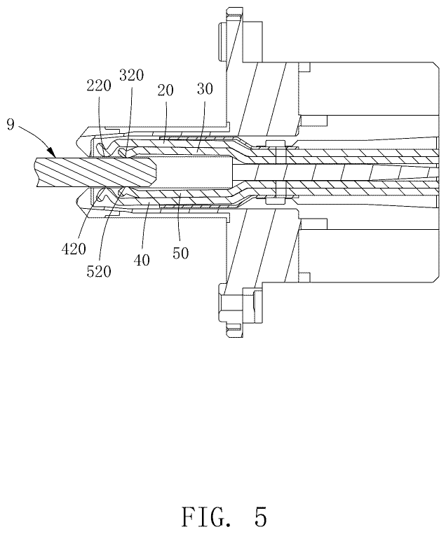

Please refer to FIGS. 4 and 5, the first contact 220 is used to first make electrical contact with the insert 9. The second contact 320 is used to make electrical contact with the insert 9 only after the first contact 220 is in electrical contact with the insert 9, and is used to finally lift the first contact 220 away from the insert 9.

The power connector 1 of the present application enables the two power terminals to transmit power together by stacking the first power terminal 20 and the second power terminal 30. The first power terminal 20 and the second power terminal 30 are respectively provided with the first contact 220 and the second contact 320 arranged adjacent to each other along the depth direction A1 of the slot 13. Therefore, the first contact 220 can make electrical contact with the insert 9 first, which may cause arcing and damage the first contact 220. However, as the insert 9 continues to be inserted, the second contact 320 smoothly makes electrical contact with the insert 9. At this point, since the first contact 220 has already been in electrical contact with the insert 9, there will be no more arc phenomenon when the second contact 320 makes electrical contact with the insert 9. Meanwhile, since the first contact 220 has been successfully lifted by the second contact 320, the first contact 220 damaged by arc will not affect power transmission. In addition, although the first contact 220 is lifted, since the first power terminal 20 and the second power terminal 30 are stacked together, the first power terminal 20 can still transmit power together with the second power terminal 30.

It can be seen that the power connector 1 of the present application protects the second contact 320 from arc damage by sacrificing the first contact 220, thereby ensuring that the second contact 320 can make normal contact with the insert 9 and ensuring that the power connector 1 can work normally.

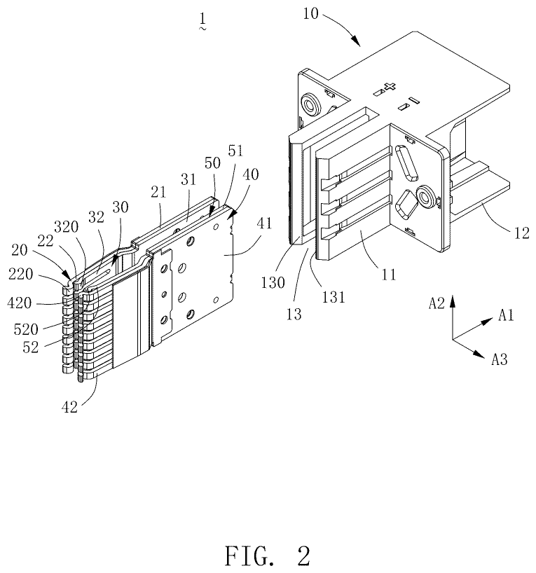

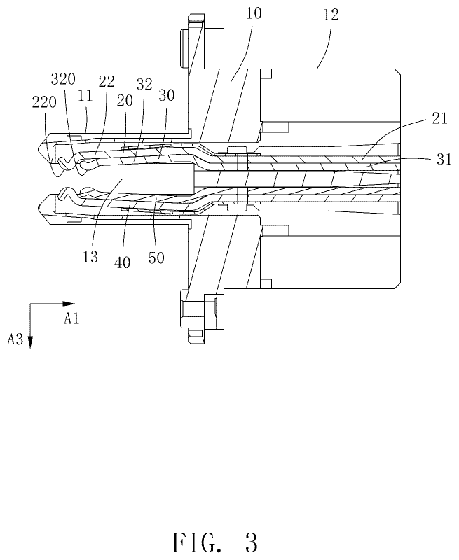

Please refer to FIG. 2, the first power terminal 20 has multiple of the first elastic arms 22 arranged in a row along a length direction A2 of the slot 13. The second power terminal 30 has multiple of the second elastic arms 32 arranged in a row along the length direction A2 of the slot 13. The first elastic arms 22 and the second elastic arms 32 are inclined toward the slot 13. Specifically, please refer to FIG. 3, the first elastic arms 22 and the second elastic arms 32 both obliquely extend into the slot 13.

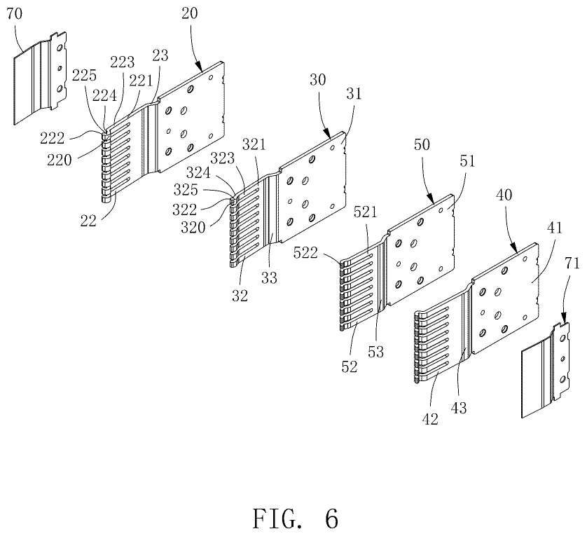

Further, referring to FIG. 6, each first elastic arm 22 has a first fixed end 221 and a first free end 222, and the first elastic arm 22 is sequentially provided with a first inclined section 223, a first bent section 224, and a first protruding structure 225 from the first fixed end 221 to the first free end 222. Wherein, the first protruding structure 225 protrudes toward the slot 13 (label seen in FIG. 3), and forms the first contact 220 on one side of the first protruding structure 225 facing the slot 13.

Similarly, referring to FIG. 6, each second elastic arm 32 has a second fixed end 321 and a second free end 322, and the second elastic arm 32 is sequentially provided with a second inclined section 323, a second bent section 324, and a second protruding structure 325 from the second fixed end 321 to the second free end 322. Wherein, the second protruding structure 325 protrudes toward the slot 13 (label seen in FIG. 3), and forms the second contact 320 on one side of the second protruding structure 325 facing the slot 13.

The power connector 1 of the present application disposes the first elastic arm 22 and the second elastic arm 32 stacked together, and arranges the first contact 220 and the second contact 320 adjacent to each other along the depth direction A1 of the slot 13, thereby ensuring that the second contact 320 successfully lifts the first contact 220 when in electrical contact with the insert 9.

It should be noted that, in this embodiment, the adjacent arrangement of the first contact 220 and the second contact 320 along the depth direction A1 of the slot 13 refers to: a straight line connecting the first contact 220 and the second contact 320 is parallel to the depth direction A1 of the slot 13. That is, in the depth direction A1 along the slot 13, the first contact 220 and the second contact 320 are arranged in a front-to-back configuration.

Furthermore, the first contact 220 and the second contact 320 have same height in a height direction A3 (label seen in FIG. 3) of the slot 13. When the second contact 320 makes electrical contact with the insert 9, the second contact 320 will be displaced and successfully lift the first contact 220.

Of course, in other embodiments, the second contact 320 may be slightly lower than the first contact 220 in the height direction A3 of the slot 13. That is to say, the second contact 320 can extend more into the slot 13 compared to the first contact 220. When the second contact 320 makes electrical contact with the insert 9, the second contact 320 will generate more displacement, thereby successfully lifting the first contact 220.

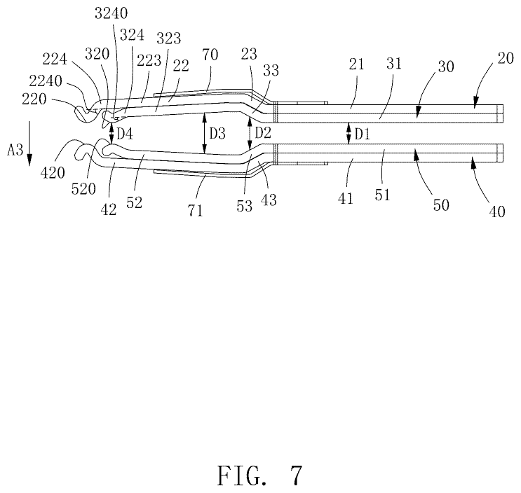

Please refer to FIG. 7, the first inclined section 223 and the second inclined section 323 are stacked together. A first bending angle 2240 of the first bent section 224 is greater than a second bending angle 3240 of the second bent section 324. The second contact 320 is corresponding to the first inclined section 223 and is located on one side of the first inclined section 223 facing the slot 13, so that the first contact 220 and the second contact 320 can be arranged in a front to back manner, and the first contact 220 and the second contact 320 have same height in the height direction A3 of the slot 13.

In one embodiment, the power connector 1 can be installed on a server rack (no shown in drawings), and the insert 9 can be a busbar. Referring to FIG. 4, the insert 9 has a first conductive surface 91 and a second conductive surface 92 disposed opposite to each other, and can be inserted into the power connector 1 to supply power to the server rack.

More specifically, as shown in FIGS. 2 and 4, the slot 13 has a first side 130 and a second side 131, which are corresponding to the first conductive surface 91 and the second conductive surface 92 of the insert 9. The first contact 220 and the second contact 320 enter into the slot 13 from the first side 130 and make electrical contact with the first conductive surface 91 of the insert 9 successively.

Please refer to FIGS. 2 to 5, in one embodiment, the power connector 1 also includes a third power terminal 40 and a fourth power terminal 50. The third power terminal 40 and the fourth power terminal 50 are stacked together and are independently of the first power terminal 20 and the second power terminal 30 stacked together. The third power terminal 40 has a third retaining plate 41 located in the assembly section 12 and at least one third elastic arm 42 located in the mating section 11. The third elastic arm 42 forms a third contact 420 that enter the slot 13 from the second side 131. The fourth power terminal 50 is stacked on one side of the third power terminal 40 facing the slot 13 and is assembled together with the third power terminal 40 into the insulation case 10. The fourth power terminal 50 has a fourth retaining plate 51 stacked with the third retaining plate 41 and at least one fourth elastic arm 52 stacked with the third elastic arm 42. The fourth elastic arm 52 forms a fourth contact 520 that enter the slot 13 from the second side 131. Wherein, the third contact 420 and the fourth contact 520 are adjacent to each other along the depth direction A1 of the slot 13. The third contact 420 is used to first make electrical contact with the second conductive surface 92 of the insert 9, and the fourth contact 520 is used to make electrical contact with the second conductive surface 92 of the insert 9 only after the third contact 420 is in electrical contact with the insert 9, and is used to lift the third contact 420 away from the insert 9.

It can be seen that the power connector 1 of the present application protects the fourth contact 520 from arc damage by sacrificing the third contact 420, thereby ensuring that the fourth contact 520 can make normal contact with the insert 9 and ensuring that the power connector 1 can work normally.

More specifically, the first power terminal 20 and the third power terminal 40 have a same structure and are symmetrically arranged in the insulation case 10; and the second power terminal 30 and the fourth power terminal 50 have a same structure and are symmetrically arranged in the insulation case 10. For example, in the embodiment, the third contact 420 and the fourth contact 520 have same height in the height direction A3 of the slot 13. But in other embodiments, the height of the third contact 420 and the fourth contact 520 may be slightly different. For example, the fourth contact 520 can extend more into the slot 13 compared to the third contact 420.

Please refer to FIGS. 6 and 7, the first power terminal 20 has a first connection section 23 located between the first retaining plate 21 and the first elastic arm 22 for connecting the first retaining plate 21 and the first elastic arm 22. The first power terminal 20 is roughly Z-shaped. The second power terminal 30 has a second connection section 33 for connecting the second retaining plate 31 and the second elastic arm 32, and the second power terminal 30 is roughly Z-shaped. Wherein, the second connection section 33 is stacked with the first connection section 23.

Similarly, the third power terminal 40 has a third connection section 43 located between the third retaining plate 41 and the third elastic arm 42. The third power terminal 40 is roughly Z-shaped. The fourth power terminal 50 has a fourth connection section 53 stacked with the third connection section 43 and located between the fourth retaining plate 51 and the fourth elastic arm 52. The fourth power terminal 50 is roughly Z-shaped.

Please refer to FIG. 7, the first retaining plate 21, the second retaining plate 31, the third retaining plate 41 and the fourth retaining plate 51 are parallel to each other. A plate spacing D1 is formed between the second retaining plate 31 and the fourth retaining plate 51, and a connection spacing D2 is formed between the second connection section 33 and the fourth connection section 53. The plate spacing D1 is less than the connection spacing D2, so as to reserve installation space for power cables. The connection spacing D2 mainly refers to a distance between a middle position of the second connection section 33 and a middle position of the fourth connection section 53.

Please refer to FIG. 6, the second elastic arm 32 has a second fixed end 321 and a second free end 322, and the second contact 320 is adjacent to the second free end 322. The fourth elastic arm 52 has a fourth fixed end 521 and a fourth free end 522, and the fourth contact 520 is adjacent to the fourth free end 522. A first spacing D3 (seen in FIG. 7) is formed between the second fixed end 321 and the fourth fixed end 521. A second spacing D4 (seen in FIG. 7) is formed between the second contact 320 and the fourth contact 520. The second spacing D4 is less than the first spacing D3, and the first spacing D3 is greater than the plate spacing D1.

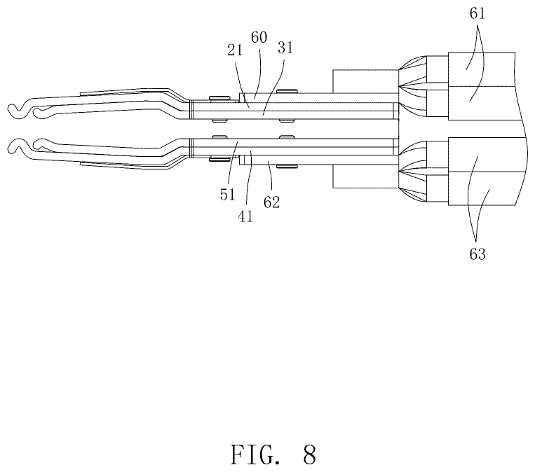

Please refer to FIG. 8, the first retaining plate 21 is fixedly connected to a least one first power cable 61 through a first welding plate 60. The first welding plate 60 is fixed on one side of the first retaining plate 21 facing away from the second retaining plate 31. The third retaining plate 41 is fixedly connected to at least one second power cable 63 through a second welding plate 62. The second welding plate 62 is fixed on one side of the third retaining plate 41 facing away from the fourth retaining plate 51.

Please refer to FIGS. 6 and 7, the power connector 1 further includes a first reinforcement sheet 70, which is stacked and fixed on one side of the first power terminal 20 facing away from the second power terminal 30, and covers a portion of the first elastic arm 22, the first connection section 23, and a portion of the first retaining plate 21. The first reinforcement sheet 70, the first power terminal 20, and the second power terminal 30 are fixed together and installed together in the insulation case 10 by means of screw fastening. The first reinforcement sheet 70 is used to enhance the structural strength of the first power terminal 20 and the second power terminal 30.

Similarly, the power connector 1 further includes a second reinforcement sheet 71, which is stacked and fixed on one side of the third power terminal 40 facing away from the fourth power terminal 50, and covers a portion of the third elastic arm 42, the third connection section 43, and a portion of the third retaining plate 41. The second reinforcement sheet 71, the third power terminal 40, and the fourth power terminal 50 are fixed together and installed together in the insulation case 10 by means of screw fastening. The second reinforcement sheet 71 is used to enhance the structural strength of the third power terminal 40 and the fourth power terminal 50.

As described above, the power connector 1 of the present application utilizes the first contact 220 and the third contact 420 to protect the second contact 320 and the fourth contact 520, respectively. Therefore, the second contact 320 and the fourth contact 520 will not generate an arc thereon when in electrical contact with the first conductive surface 91 and the second conductive surface 92 of the insert 9, and will not be damaged. The power connector 1 of the present application also utilizes the second contact 320 and the fourth contact 520 to lift the first contact 220 and the third contact 420 away from the insert 9, respectively, to prevent the damaged first contact 220 and the damaged third contact 420 from affecting power transmission. In addition, although the first contact 220 and the third contact 420 are successfully lifted, but the first power terminal 20 and the second power terminal 30 are stacked together, and the third power terminal 40 and the fourth power terminal 50 are stacked together, thus the first power terminal 20 can still transmit power together with the second power terminal 30, and the third power terminal 40 can still transmit power together with the fourth power terminal 50.

It should be understood that, the application of the present application is not limited to the above examples listed. Ordinary technical personnel in this field can improve or change the applications according to the above descriptions, all of these improvements and transforms should belong to the scope of protection in the appended claims of the present application.

What is claimed is:

1. A power connector, comprising:
an insulation case, having a mating section and an assembly section; the mating section being provided with a slot for inserting an insert;
a first power terminal, having a first retaining plate located in the assembly section and at least one first elastic arm located in the mating section; the first elastic arm forming a first contact that enter the slot; and
a second power terminal, being stacked on one side of the first power terminal facing the slot and being assembled together with the first power terminal into the insulation case; the second power terminal having a second retaining plate stacked with the first retaining plate and at least one second elastic arm stacked with the first elastic arm; the second elastic arm forming a second contact that enter the slot;
wherein, the first contact and the second contact are adjacent to each other along a depth direction of the slot; the first contact is used to first make electrical contact with the insert, and the second contact is used to make electrical contact with the insert only after the first contact is in electrical contact with the insert, and lift the first contact away from the insert.

2. The power connector according to claim 1, wherein,
in a height direction of the slot, the first contact and the second contact have same height.

3. The power connector according to claim 1, wherein,
in a height direction of the slot, the second contact is lower than the first contact for entering more into the slot compared to the first contact.

4. The power connector according to claim 1, wherein,
the first elastic arm and the second elastic arm are both inclined toward the slot.

5. The power connector according to claim 4, wherein,
the first elastic arm has a first fixed end and a first free end, and the first elastic arm is sequentially provided with a first inclined section, a first bent section, and a first protruding structure from the first fixed end to the first free end; wherein, the first protruding structure protrudes toward the slot, and forms the first contact on one side of the first protruding structure facing the slot; and
the second elastic arm has a second fixed end and a second free end, and the second elastic arm is sequentially provided with a second inclined section, a second bent section, and a second protruding structure from the second fixed end to the second free end; wherein, the second protruding structure protrudes toward the slot, and forms the second contact on one side of the second protruding structure facing the slot;
wherein, the first inclined section and the second inclined section are stacked together;
wherein, a first bending angle of the first bent section is greater than a second bending angle of the second bent section; and
wherein, the second contact is corresponding to the first inclined section and is located on one side of the first inclined section facing the slot.

6. The power connector according to claim 5, wherein,
the first power terminal has a first connection section for connecting the first retaining plate and the first elastic arm, and the first power terminal is Z-shaped; and
the second power terminal has a second connection section for connecting the second retaining plate and the second elastic arm, and the second power terminal is Z-shaped;
wherein, the second connection section is stacked with the first connection section.

7. The power connector according to claim 6, comprising:
a first reinforcement sheet, being stacked and fixed on one side of the first power terminal facing away from the second power terminal;
wherein, the first reinforcement sheet covers a portion of the first elastic arm, the first connection section, and a portion of the first retaining plate.

8. The power connector according to claim 1, wherein,
the first power terminal has multiple of the first elastic arms arranged in a row along a length direction of the slot; and
the second power terminal has multiple of the second elastic arms arranged in a row along the length direction of the slot.

9. A power connector, comprising:
an insulation case, having a mating section and an assembly section; the mating section being provided with a slot for inserting an insert; the slot having a first side and a second side, which are oppositely arranged and are corresponding to a first conductive surface and a second conductive surface of the insert, respectively;
a first power terminal, having a first retaining plate located in the assembly section and at least one first elastic arm located in the mating section; the first elastic arm forming a first contact that enter the slot from the first side;
a second power terminal, being stacked on one side of the first power terminal facing the slot and being assembled together with the first power terminal into the insulation case; the second power terminal having a second retaining plate stacked with the first retaining plate and at least one second elastic arm stacked with the first elastic arm; the second elastic arm forming a second contact that enter the slot from the first side;
a third power terminal, being independent of the first and second power terminals, and having a third retaining plate located in the assembly section and at least one third elastic arm located in the mating section; the third elastic arm forming a third contact that enter the slot from the second side; and
a fourth power terminal, being independent of the first and second power terminals, being stacked on one side of the third power terminal facing the slot, and being assembled together with the third power terminal into the insulation case; the fourth power terminal having a fourth retaining plate stacked with the third retaining plate and at least one fourth elastic arm stacked with the third elastic arm; the fourth elastic arm forming a fourth contact that enter the slot from the second side;
wherein, the first contact and the second contact are adjacent to each other along a depth direction of the slot; the first contact is used to first make electrical contact with the first conductive surface of the insert, and the second contact is used to make electrical contact with the first conductive surface of the insert only after the first contact is in electrical contact with the insert, and lift the first contact away from the insert; and
wherein, the third contact and the fourth contact are adjacent to each other along the depth direction of the slot; the third contact is used to first make electrical contact with the second conductive surface of the insert, and the fourth contact is used to make electrical contact with the second conductive surface of the insert only after the third contact is in electrical contact with the insert, and lift the third contact away from the insert.

10. The power connector according to claim 9, wherein,
the first power terminal and the third power terminal have a same structure and are symmetrically arranged in the insulation case; and
the second power terminal and the fourth power terminal have a same structure and are symmetrically arranged in the insulation case.

11. The power connector according to claim 9, wherein,
the first power terminal has a first connection section located between the first retaining plate and the first elastic arm;
the second power terminal has a second connection section stacked with the first connection section and located between the second retaining plate and the second elastic arm;
the third power terminal has a third connection section located between the third retaining plate and the third elastic arm; and
the fourth power terminal has a fourth connection section stacked with the third connection section and located between the fourth retaining plate and the fourth elastic arm.

12. The power connector according to claim 11, wherein,
the first retaining plate, the second retaining plate, the third retaining plate and the fourth retaining plate are parallel to each other;
a plate spacing is formed between the second retaining plate and the fourth retaining plate; and
a connection spacing is formed between the second connection section and the fourth connection section;
wherein, the plate spacing is less than the connection spacing.

13. The power connector according to claim 12, wherein,
the second elastic arm has a second fixed end and a second free end, and the second contact is adjacent to the second free end;
the fourth elastic arm has a fourth fixed end and a fourth free end, and the fourth contact is adjacent to the fourth free end;
a first spacing is formed between the second fixed end and the fourth fixed end; and
a second spacing is formed between the second contact and the fourth contact;
wherein, the second spacing is less than the first spacing; and the first spacing is greater than the plate spacing.

14. The power connector according to claim 9, wherein,
the first retaining plate is fixedly connected to at least one first power cable through a first welding plate;
the first welding plate is fixed on one side of the first retaining plate facing away from the second retaining plate;
the third retaining plate is fixedly connected to at least one second power cable through a second welding plate; and
the second welding plate is fixed on one side of the third retaining plate facing away from the fourth retaining plate.

15. The power connector according to claim 11, comprising:
a first reinforcement sheet, being stacked and fixed on one side of the first power terminal facing away from the second power terminal; wherein, the first reinforcement sheet covers a portion of the first elastic arm, the first connection section, and a portion of the first retaining plate; and
a second reinforcement sheet, being stacked and fixed on one side of the third power terminal facing away from the fourth power terminal; wherein, the second reinforcement sheet covers a portion of the third elastic arm, the third connection section, and a portion of the third retaining plate.
